(19) United States
(12) Patent Application Publication
(10) Pub. No.: US 2026/0280940 A1
(43) Pub. Date: Sep. 17, 2026

(54) METHODS, APPARATUSES AND SYSTEMS FOR INTELLIGENT REFLECTION SURFACE INSTALLED USER EQUIPMENT CHANNEL ESTIMATION

(71) Applicant: KYOCERA CORPORATION, Kyoto-shi, Kyoto (JP)

(72) Inventors: Amit KALHAN, San Diego, CA (US); Ramon KHALONA, San Diego, CA (US)

(21) Appl. No.: 19/167,971

(22) PCT Filed: Mar. 26, 2024
(86) PCT No.: PCT/US2024/021508

§ 371 Date: Sep. 23, 2025

Related U.S. Application Data
(60) Provisional application No. 63/456,874, filed on Apr. 4, 2023.

(51) Int. Cl. H04L 25/02; H04B 7/04

(52) U.S. Cl. CPC H04L 25/0224; H04B 7/04013

(57) ABSTRACT

Methods, apparatuses and systems for intelligent reflection surface (IRS) installed user equipment (UE) channel estimation. In one embodiment, a wireless communication node includes: a transceiver configured to transmit a first signal, a plurality of second signals and a plurality of third signals to a wireless communication device, wherein the first signal comprises a configuration message to instruct the wireless communication device to receive a plurality of second signals and a plurality of third signals; and a receiver configured to receive a plurality of fourth signals generated by an Intelligent Reflecting Surface (IRS) coupled to the wireless communication device, wherein the plurality of fourth signals is generated by the IRS by reflecting the plurality of third signals, and wherein the plurality of fourth signals is used to perform a channel estimation between the wireless communication device and the wireless communication node.

### TECHNICAL FIELD

The disclosure relates generally to wireless communications and, more particularly, to methods, apparatuses and systems for intelligent reflection surface (IRS) installed user equipment (UE) channel estimation.

### BACKGROUND

An IRS is a planar surface comprising a plurality of small, reconfigurable reflecting elements, each of which can induce a controllable amplitude, phase and/or polarization change to the incident signal independently, without need of baseband processing. IRSs are designed to reflect, refract, or scatter incoming electromagnetic waves in a way that optimizes signal strength, minimizes interference, and enhances overall wireless communication performance.

On the other hand, in a wireless communication system, signals are transmitted through wireless channels established between transmitters and receivers. These channels introduce various impairments and distortions to the transmitted signals due to factors such as fading, interference, and noise. Channel estimation in wireless communication is a process used to estimate the characteristics of the communication channel through which signals are transmitted. In systems using pilot symbols for channel estimation, when neighboring cells or users share the same pilot frequencies, pilot contamination resulting in interference and inaccuracies in channel estimation can occur due to large number of neighboring cells or user equipment. In addition, dedicated pilot symbols and reference signals used for channel estimation add overhead to the communication system. Furthermore, channel conditions in a wireless communication system can change rapidly, especially in mobile environments. Current channel estimation methods may struggle to accurately track and adapt to fast-changing channel conditions. Therefore, there is a need to develop new methods and systems for improving channel estimation accuracy and reliability in wireless communication systems.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method includes: receiving, at a wireless communication device, a first signal, a plurality of second signals and a plurality of third signals from a wireless communication node, wherein the first signal comprises a configuration message to instruct the wireless communication device to receive a plurality of second signals and a plurality of third signals; reflecting, at the wireless communication device, the plurality of third signals to generate a plurality of fourth signals using an Intelligent Reflecting Surface (IRS) coupled to the wireless communication device, wherein the plurality of fourth signals is used to perform a channel estimation between the wireless communication device and the wireless communication node.

In some embodiments, the first signal includes a configuration message to instruct the wireless communication device to set at least one angle of departure (AoD) for the plurality of fourth signals based on at least one angle of arrival (AoA) of the plurality of second signals measured at the wireless communication device.

In some embodiments, the first signal is: transmitted through system information block (SIB) signaling; transmitted through SIB Type 1 (SIB1) signaling; transmitted through radio resource control (RRC) signaling; transmitted through medium access control-control element (MAC-CE) signaling; transmitted through downlink control information (DCI) signaling; transmitted via a paging message; or pre-configured in the wireless communication device.

In some embodiments, the plurality of fourth signals is transmitted from the wireless communication device to the wireless communication node by focusing a transmission direction towards the wireless communication node such that a signal strength of the plurality of fourth signals is higher than a threshold. In some embodiments, the configuration message further comprises an instruction to set: the at least one AoD for the plurality of fourth signals to be the same as the at least one AoA of the plurality of second signals; and at least one of: a reference signal identification (ID), a device ID for the wireless communication device, and a device-specific reference signal downlink resource assignment. In some embodiments, the at least one AoA of the plurality of second signals is determined using one of the following: Capon's Minimum Variance method, MUltiple SIgnal Classification (MUSIC) method, Estimation of Signal Parameters via Rotational Invariance Techniques (ESPRIT) method, and Matrix-Pencil method.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates exemplary wireless communication network for wireless communication and positioning, in accordance with some embodiments of the present disclosure.

FIG. 3 illustrates another exemplary wireless communication network for wireless communication and positioning, in accordance with some embodiments of the present disclosure.

FIG. 4 illustrates a signal reflection diagram of an intelligent reflection surface, in accordance with some embodiments of the present disclosure.

FIG. 5 illustrates an exemplary signaling diagram of a conventional method for channel estimation.

FIG. 6 illustrates an exemplary signaling diagram for intelligent reflection surface installed user equipment channel estimation, in accordance with some embodiments of the present disclosure.

FIG. 7 illustrates an exemplary diagram of a communication link between a base station and an intelligent reflection surface coupled to a user equipment, in accordance with some embodiments of the present disclosure.

FIG. 8 illustrates an example method for performing IRS installed UE channel estimation, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

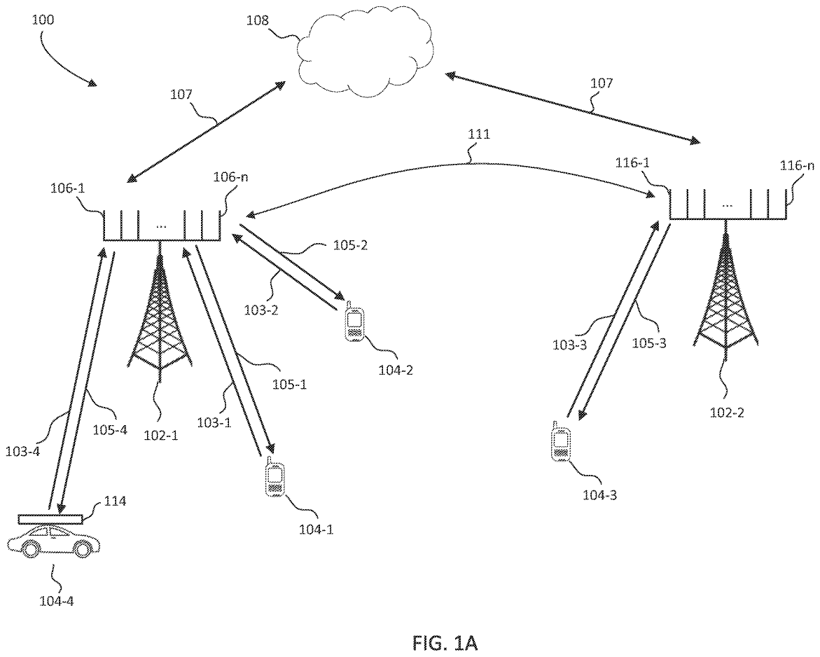

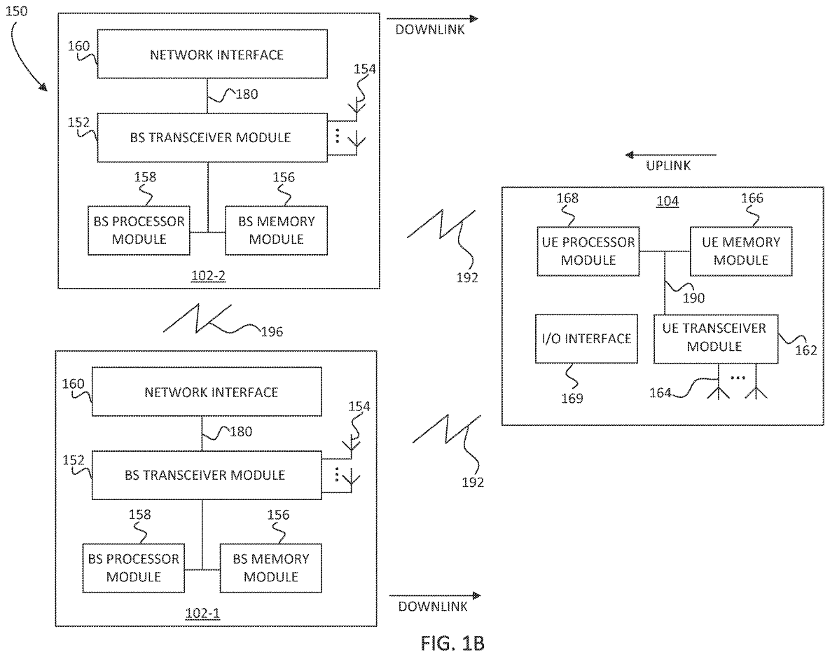

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device” herein. Such communication nodes and communication devices may be capable of wireless and/or wired communications, in accordance with various embodiments of the invention. It is noted that all the embodiments are merely preferred examples and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, a first UE 104-1, a second UE 104-2, a third UE 104-3, and a fourth UE 104-4. In some embodiments, the first BS 102-1 and the second BS 102-2 comprise a first plurality of antennas 106-1 to 106-n and a second plurality of antennas 116-1 to 116-n, respectively. The first plurality of antennas 106-1 to 106-n may communicate with a plurality of UEs 104 to form a first multiple-input multiple-output (MIMO) system, and the second plurality of antennas 116-1 to 116-n may communicate with the plurality of UEs 104 to form a second MIMO system.

In some embodiments, a plurality of UEs 104 may form direct communication (i.e., uplink) channels 103-1, 103-2, 103-3, and 103-4 with the first BS 102-1 and the second BS 102-2. In some embodiments, the plurality of UEs 104 may also form direct communication (i.e., downlink) channels 105-1, 105-2, 105-3, and 105-4 with the first BS 102-1 and the second BS 102-2. The direct communication channels between the plurality of UEs 104 and a distributed unit of the BS 102 can be through interfaces such as an Uu interface, which is also known as E-UTRAN air interface. In some embodiments, the UE 104 comprises a plurality of transceivers which enables the UE 104 to support multi connectivity so as to receive data simultaneously from the first BS 102-1 and the second BS 102-2. The first BS 102-1 and the second BS 102-2 each is connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), User Plane Function (UPF), and System Management Function (SMF).

A direct communication channel 111 between the first BS 102-1 and the second 102-2 is through an X2 interface. In some embodiments, a BS (gNB) is split into a Distributed Unit (DU) and a Central Unit (CU) on the UP, between which the direct communication is through a F1-U interface. In some embodiments, a CU of the second BS 102-2 can be further split into a Control Plane (CP) and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the CP and/or data on the UP.

In some embodiments, one of the plurality of UEs 104, such as the UE 104-4 may comprise an Intelligent Reflecting Surface (IRS) 114 attached to the main body of the UE 104-4. The IRS 114 may be referred to as a planar surface comprising a plurality of small, reconfigurable reflecting elements, each of which can induce a controllable amplitude, phase and/or polarization change to the incident signal independently, without any need of baseband processing. In one embodiment, the UE 104-4 is a vehicle, and the IRS 114 may be installed on the roof of the UE 104-4. In another embodiment, the IRS 114 is installed on mobile robots of the UE 104-4. In yet another embodiment, the UE 104-4 is an uncrewed aerial vehicle (UAV) and the IRS 114 is placed facing the ground. In still another embodiment, the UE 104-4 is a handheld device, and the IRS 114 is installed on the UE 104-4. In some embodiments, the UE 104-4 is connected to the IRS 114 through a wire while the UE 104-4 and the IRS 114 are located at different locations. In some other embodiments, the UE 104-4 and the IRS 114 are located at different locations, and the UE 104-4 is connected to the IRS 114 through a wireless communication channel using antennas installed on both the UE 104-4 and the IRS 114. In one embodiment, the IRS 114 is configured to reflect incident signals transmitted from the BS 102-1 for positioning estimation of the UE 104-4, while the UE 104-4 and the IRS 114 are located at different locations. In this embodiment, the UE 104-4 may be configured to transmit a UE message (e.g. UE capability message) to the BS 102-1, wherein the UE message comprises the location of the IRS 114 (e.g. distance and direction) relative to the UE 104-4. In this way, the BS 102-1 may determine the exact location of the IRS 114 using the location of the IRS 114 relative to the UE 104-4 and the exact location of the UE 104-4. In another embodiment, the exact location of the IRS 114 is predetermined and transmitted to the BS 102-1 through the UE message. In yet another embodiment, the exact location of the IRS 114 is predetermined and stored in the BS 102-1. In some embodiments, the BS 102-1 is configured to generate incident signals to the UE 104-4, and the UE 104-4 may be configured to reflect the incident signals towards specific directions using the installed IRS 114 for channel estimation between the BS 102-1 and the UE 104-4.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a date communication bus 190. The BS 102 communicates with the UE 104 via a communication channel 192, which can be any wireless channel or other medium known in the art suitable for transmission of data as described herein.

As would be understood by persons of ordinary skill in the art, the system 150 may further include any number of modules other than the modules shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192 and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

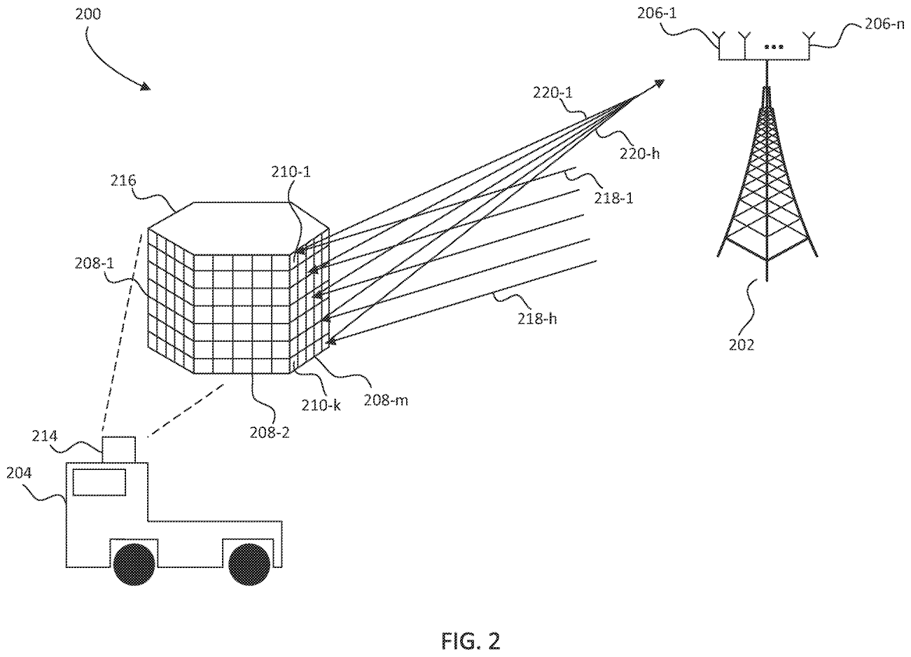

FIG. 2 illustrates an exemplary wireless communication network 200 for wireless communication and positioning, in accordance with some embodiments of the present disclosure. In some embodiments, the exemplary wireless communication network 200 comprises a BS 202 and a UE 204. In some embodiments, the BS 202 comprises a plurality of antennas 206-1 to 206-n as shown. The plurality of antennas 206-1 to 206-n may be arranged in an antenna array and be in communication with the UE 204 to form a multiple input and single output (MISO) system. In some embodiments, the plurality of antennas 206-1 to 206-n is configured to form a uniform linear antenna array. In some other embodiments, the plurality of antennas 206-1 to 206-n may form a planar antenna array or a frequency scanning antenna array. Although FIG. 2 illustrates an embodiment of a MISO system, the present disclosure is not limited to MISO systems, and can be applied to other types of communication systems, such as MIMO systems, single input multiple output (SIMO) systems, and single input single output (SISO) systems. In some embodiments, the antennas in the plurality of antennas 206-1 to 206-n are evenly spaced on a straight line, wherein each pair of neighbored antennas has a fixed distance. In some other embodiments, the antennas in the plurality of antennas 206-1 to 206-n are arranged on a straight line, wherein different pairs of neighbored antennas have different distances.

In some embodiments, the UE 204 comprises an IRS 214 attached to the main body of the UE 204. In some other embodiments, the UE 204 is a vehicle, and the IRS 214 may be installed on the roof or on the side panels of the UE 204. In yet some other embodiments, the IRS 214 is installed on mobile robots of the UE 204. In still some other embodiments, the UE 204 is a UAV and the IRS 214 is placed facing the ground. In still some other embodiments, the UE 204 comprises the IRS 214 and the IRS 214 is integrated as a component in the UE 204. In still some other embodiments, the UE 204 is a handheld device, and the IRS 214 is installed on the UE 204. The UE 204 may be connected to the IRS 214 through a wire or a wireless communication channel while the UE 204 and the IRS 214 are located at different locations.

In some embodiments, the IRS 214 comprises one or more intelligent reflection surfaces. A zoomed view 216 of the IRS 214 is shown in FIG. 2. In some embodiments, the zoomed view 216 of the IRS 214 comprises a plurality of intelligent reflection surfaces 208-1 to 208-m placed on side surfaces of a polygonal cylinder shape as shown. Each of the intelligent reflection surfaces 208-1 to 208-m may comprises a plurality of reconfigurable reflecting elements. For example, the intelligent reflection surface 208-m may comprise a plurality of reconfigurable reflecting elements 210-1 to 210-k. In one embodiment, each of the plurality of reconfigurable reflecting elements 210-1 to 210-k comprises a respective metallic patch printed on a dielectric substrate, and each of the respective metallic patches can be configured to manipulate incident signals. In some other embodiments, a control circuit board installed in the IRS 214 can be configured to activate the plurality of reconfigurable reflecting elements 210-1 to 210-k.

In some embodiments, the plurality of antennas 206-1 to 206-n in the BS 202 may be in communication with the respective plurality of reconfigurable reflecting elements in each of the plurality of intelligent reflection surfaces 208-1 to 208-m to form a MIMO system. For example, the plurality of antennas 206-1 to 206-n and the plurality of reconfigurable reflecting elements 210-1 to 210-k may form a first MIMO system for positioning estimation of the UE 204. In the first MIMO system, the BS 202 comprising the plurality of antennas 206-1 to 206-n may be configured to transmit a first plurality of signals 218-1 to 218-h to the plurality of reconfigurable reflecting elements 210-1 to 210-k, wherein each of the plurality of reconfigurable reflecting elements 210-1 to 210-k are configured to receive the first plurality of signals 218-1 to 218-h. Upon receiving the first plurality of signals 218-1 to 218-h, each of the plurality of reconfigurable reflecting elements 210-1 to 210-k may be configured to reflect the first plurality of signals 218-1 to 218-h to produce a respective one of a plurality reflected second signals 220-1 to 220-h. In some embodiments, for the first plurality of signals 218-1 to 218-h received at the IRS 214, a respective AoA at each of the plurality of reconfigurable reflecting elements 210-1 to 210-k is slightly different due to slight different locations of each of the plurality of reconfigurable reflecting elements 210-1 to 210-k. In such a case, the amplitude and/or phase shifts in each of the plurality of reconfigurable reflecting elements 210-1 to 210-k may be jointly adjusted such that each of the plurality of reconfigurable reflecting elements 210-1 to 210-k reflects the first plurality of signals 218-1 to 218-h at its respective AoA to form a beam that reaches the destination node with the maximum power. In some embodiments, each of the plurality of reconfigurable reflecting elements 210-1 to 210-k reflects the first plurality of signals 218-1 to 218-h to generate a respective one of a plurality of reflected second signals 220-1 to 220-h, such that the plurality of reflected second signals 220-1 to 220-h is focused towards the transmission node BS 202. In some embodiments, the plurality of reflected second signals 220-1 to 220-h forms a beam that reaches the destination node with the maximum power. In some embodiments, the power value of the beam formed by the plurality reflected second signals 220-1 to 220-h is larger than the corresponding power value in each of the plurality reflected second signals 220-1 to 220-h.

In one embodiment, the plurality of reconfigurable reflecting elements 210-1 to 210-k is adjusted by mechanical actuation via mechanical rotation to control the directions of the plurality reflected second signals 220-1 to 220-h. In another embodiment, the plurality of reconfigurable reflecting elements 210-1 to 210-k is adjusted by functional materials such as liquid crystal or graphene. In yet another embodiment, the plurality of reconfigurable reflecting elements 210-1 to 210-k is adjusted by electronic devices such as positive-intrinsic-negative (PIN) diodes, field-effect transistors (FETs), or micro-electromechanical system (MEMS) switches. The electronic devices used for controlling reflection of incident signals may provide fast response time, low reflection loss as well as relatively low energy consumption and hardware cost.

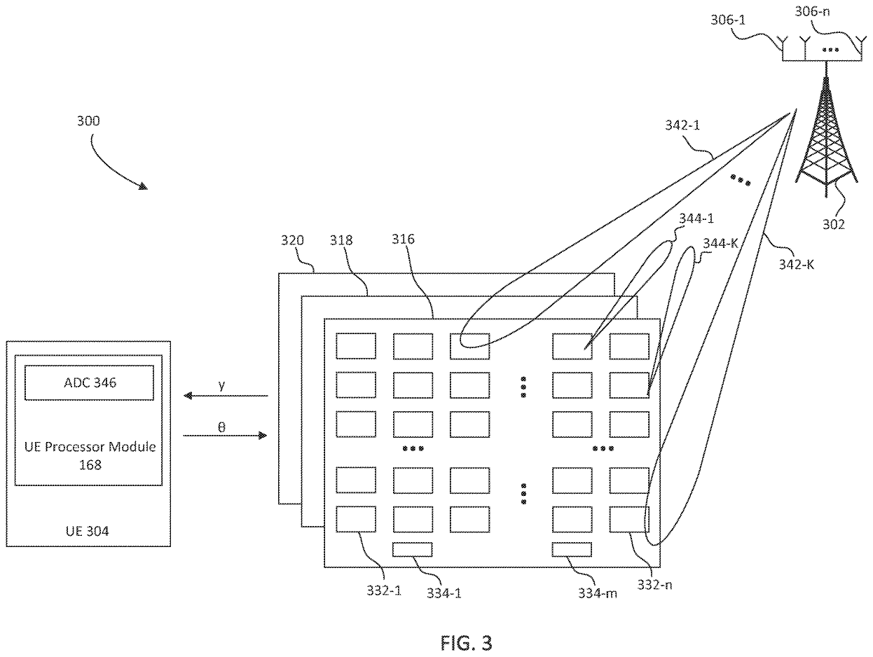

FIG. 3 illustrates another exemplary wireless communication network 300 for wireless communication and positioning, in accordance with some embodiments of the present disclosure. In some embodiments, the IRS 214 as shown in FIG. 2 may be in communication with a BS 302 comprising a plurality of antennas 306-1 to 306-n for UE positioning estimation of a UE 304, wherein the IRS 214 comprises a first/outside layer 316, a second/intermediate layer 318 and a third/inside layer 320.

In some embodiments, the first/outside layer 316 comprises a plurality of reconfigurable reflecting elements 332-1 to 332-n. In one embodiment, each of the plurality of reconfigurable reflecting elements 332-1 to 332-n comprises a respective metallic patch printed on a dielectric substrate, and each of the respective metallic patches can be configured to manipulate incident signals. In some other embodiments, the second/intermediate layer 318 comprises a copper plate used to reduce signal energy leakage during IRS's reflection. In yet some other embodiments, the third/inside layer 320 comprises a control circuit board, wherein the control circuit board can be configured to activate the plurality of reconfigurable reflecting elements 332-1 to 332-n. In some embodiments, the control circuit board in the third/inside layer 220 is configured to tune the reflection amplitude and/or phase shifts in each of the reconfigurable reflecting elements 332-1 to 332-n at real time. In some embodiments, the UE 304 comprising the UE processor module 168 shown in FIG. 1B may be coupled to the IRS 214 for controlling operations in the control circuit board in the third/inside layer 320. In one embodiment, the UE processor module 168 acts as a gateway to communicate with other network components in the network through wired or wireless backhaul/control links.

In some embodiments, a plurality of sensors 334-1 to 334-m can be deployed in the first/outside layer 316 to enhance the environmental learning capability of the IRS 214. In one embodiment, each of the plurality of reconfigurable reflecting elements 332-1 to 332-n is associated with a respective sensor from the plurality of sensors 334-1 to 334-m. In another embodiment, the plurality of sensors 334-1 to 334-m is interlaced with the plurality of reconfigurable reflecting elements 332-1 to 332-n in the first/outside layer 316. In yet another embodiment, each of the plurality of sensors 334-1 to 334-m is configured to sense the surrounding radio signals of interest to facilitate the UE Processor Module in designing the reflection coefficient for the respective one of the plurality of reconfigurable reflecting elements 332-1 to 332-n.

In some embodiments, the plurality of sensors 334-1 to 334-m is configured to receive incident signals from the BS 302. Upon receiving the incident signals from the BS 302, the plurality of sensors 334-1 to 334-m may be configured to down convert the received incident signals into analog signals using frequency translation to shift the original radio frequency (RF) incident signals to analog signals of lower frequency. In some embodiments, signal filtering and amplification can also be performed in the down-conversion process. Once the incident signals are down converted into analog signals, as shown by the analog signal y in FIG. 3, the analog signal y may be transmitted from the IRS 214 to the UE processor module 168, wherein the UE processor module 168 comprises an analog-to-digital convertor (ADC) 346 to convert the analog signal y to corresponding digital baseband signals for digital baseband processing. Using the digital baseband signals from the output of the ADC 346, the UE processor module 168 may be configured to estimate the angle of arrival (AoA) of the received incident signals from the BS 302, as well as the distance between the IRS 214 and the transmitting node BS 302. Examples of algorithms that can be applied to estimate the AoA of the received incident signals from the BS 302 and the distance between the IRS 214 and the transmitting node BS 302 include Capon's Minimum Variance, MUltiple SIgnal Classification (MUSIC), Estimation of Signal Parameters via Rotational Invariance Techniques (ESPRIT), and Matrix-Pencil method. In this way, UE positioning estimation can be performed by receiving reference signals from a single transmitting point, as shown by the single BS 302 in FIG. 2.

Relative to conventional positioning methods, one of the most significant advantages with the exemplary architecture of IRS for UE positioning shown in FIG. 3 is the energy savings and reduced signaling overhead. Upon receiving a plurality of reference incident signals 342-1 to 342-K from the BS 302, the UE 304 comprising the UE processor module 168 is not required to transmit positioning measurement reports back to the serving BS 302. Instead, the IRS 214 comprising the plurality of reconfigurable reflecting elements 332-1 to 332-n is configured to reflect the plurality of reference incident signals 342-1 to 342-K to produce a plurality of reflected signals 344-1 to 344-K for UE positioning estimation. Since no data transmissions are needed at the UE 304 during the incident signal reflection, the UE 304 does not establish a connection with the serving BS 302 during the IRS reflection procedure. This allows the UE 304 not to be in the CONNECTED state during the positioning process. In some embodiments, a new POSITIONING state may be used during the IRS reflection procedure, wherein the UE 304 is in a listen-only mode in the new POSITIONING state. In some other embodiments, the UE 304 and the coupled IRS 214 are configured by the network for IRS reflection.

In some embodiments, the BS 302 may receive a measurement initiation request from a location management server (LMS), wherein the measurement initiation request may be a new radio (NR) Reference Signal Received Power (RSRP) measurement initiation request, an NR Reference Signal Received Quality (RSRQ) measurement initiation request, an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request may indicate a request for UE positioning based on IRS. In some other embodiments, to optimize beam management, the BS 302 may request the LMS to initiate a UE positioning calculation procedure for the UE 304.

In some embodiments, the measurement initiation request comprises downlink positioning reference signal (DL-PRS) configurations, wherein the DL-PRS configurations comprise at least one of: positioning reference signal (PRS) resources, muting resources, PRS pattern and periodicity, and a list of measurements to be reported back to the core network, wherein the list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) of the PRS transmission. In some other embodiment, the DL-PRS configurations are pre-configured in the BS 302. In yet some another embodiments, the DL-PRS configurations are pre-configured in the UE 304, and the UE 304 is pre-configured to reflect incident signals from the BS 302 towards the same direction as the incident signals.

In some embodiments, upon receiving the measurement initiation request, the BS 302 may transmit a first signal to the UE 304 for performing UE positioning. In some embodiments, the first signal comprises an indication to instruct the UE 304 to receive and reflect DL-PRS back towards the corresponding transmitting node that sends the DL-PRS. In some embodiments, the indication instructs the UE 304 to reflect the DL-PRS back to the corresponding transmitting node using the IRS 214. In some other embodiments, the indication instructs the UE 304 to reflect the DL-PRS back to the corresponding transmitting node in the same direction of the incident DL-PRS.

In some embodiments, the first signal sent from the BS 302 to the UE 304 may be transmitted through system information block (SIB) signaling, radio resource control (RRC) signaling, medium access control-control element (MAC-CE) signaling, or downlink control information (DCI) signaling. In some other embodiments, the indication for instructing the UE 304 to reflect the DL-PRS may be pre-configured in the UE 304 or sent to the UE 304 from the BS 302 via a paging message. In one embodiment, the first signal is transmitted through an SIB Type 1 (SIB1) signaling message, wherein the SIB1 signaling message is periodically transmitted from the BS 302 to the UE 304, such that the SIB1 signaling message can be transmitted to the UE 304 even when the UE 304 is still in IDLE or INACTIVE state.

After transmitting the first signal to the UE 304, the BS 302 may be configured to transmit a plurality of second signals to the UE 304. In some embodiments, the plurality of second signals comprises reference signals for channel estimation. In some other embodiments, each of the plurality of second signals comprises a respective DL-PRS with a respective AoA for performing UE positioning for the UE 304, wherein the respective DL-PRS comprises resource allocation information for downlink transmission, modulation and coding schemes, and pilot/reference signals for UE positioning measurements. Upon receiving each of the plurality of second signals, the UE 304 may be configured to measure the respective AoA (e.g. θ₁, . . . , θₖ) for each of the plurality of second signals using the plurality of sensors 334-1 to 334-m.

In some embodiments, once the respective AoA for each of the plurality of second signals is measured, the IRS 214 may be configured to reflect each of the plurality of second signals back towards the transmitting node BS 302 with the same direction as measured in the respective AoA for each of the plurality of second signals. In one embodiment, the IRS 214 comprises the plurality of reconfigurable reflecting elements 332-1 to 332-n and the plurality of sensors 334-1 to 334-m, and the plurality of reconfigurable reflecting elements 332-1 to 332-n is coordinated to reflect each of the plurality of second signals back towards the BS 302 with the same direction as measured in the AoA for each of the plurality of second signals. In another embodiment, the plurality of reconfigurable reflecting elements 332-1 to 332-n is coordinated to focus each of the reflected second signals such that the DL-PRS transmitting node BS 302 receives the reflected second signals at sufficient receive strength.

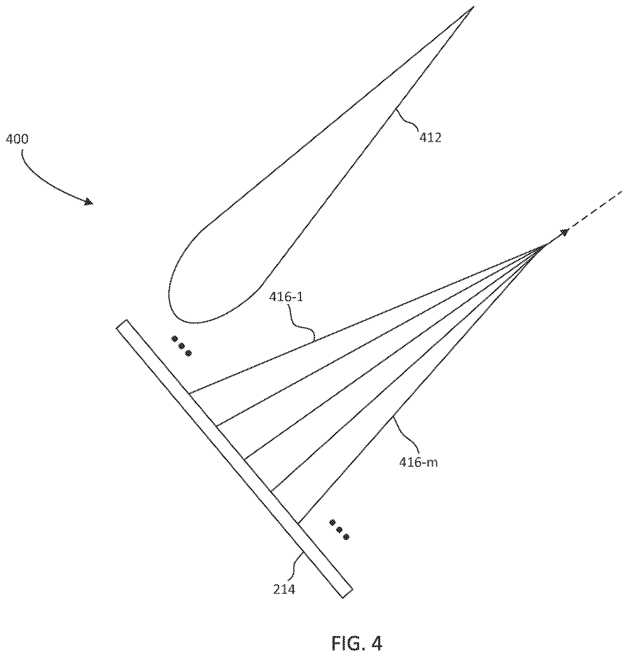

As illustrated in a signal reflection diagram 400 in FIG. 4, upon receiving a second signal 412, each of the plurality of reconfigurable reflecting elements 332-1 to 332-n in the IRS 214 may be configured to reflect the second signal 412 to produce a respective one of a plurality reflected second signals 416-1 to 416-m. In some embodiments, for the second signal 412 received at the IRS 214, a respective AoA at each of the plurality of reconfigurable reflecting elements 332-1 to 332-n is slightly different due to slight different locations of each of the plurality of reconfigurable reflecting elements 332-1 to 332-n. In such a case, the amplitude and/or phase shifts in each of the plurality of reconfigurable reflecting elements 332-1 to 332-n may be jointly adjusted such that each of the plurality of reconfigurable reflecting elements 332-1 to 332-n reflects the second signal 412 at its respective AoA to form a beam that reaches the destination node with the maximum power. In some embodiments, each of the plurality of reconfigurable reflecting elements 332-1 to 332-n reflects the second signal 412 to generate a respective one of a plurality of reflected second signals 416-1 to 416-m, such that the plurality of reflected second signals 416-1 to 416-m is focused towards the transmission node BS 302. In some embodiments, the plurality of reflected second signals 416-1 to 416-m forms a beam that reaches the destination node with the maximum power. In some embodiments, the power value of the beam formed by the plurality reflected second signals 416-1 to 416-m is larger than the corresponding power value in each of the plurality reflected second signals 416-1 to 416-m.

During the transmission of signals between the BS 302 and the UE 304, the established wireless transmission channels between the BS 302 and the UE 304 may introduce various impairments and distortions to the transmitted signals due to factors such as fading, interference, and noise. Channel estimation can be performed to estimate the characteristics of the communication channel between the BS 302 and the UE 304 to optimize wireless communication system performance and to improve the reliability of communication. A conventional way to perform channel estimation is to use channel reciprocity for MIMO precoding in the downlink by estimating the UL channel based on the symmetry properties between the UL and DL channels. That is, a UE can periodically transmit pilot signals or Sounding Reference Signals (SRSs) during specific time slots allocated for UL channel sounding, and a corresponding BS can measures the received SRSs to estimate the UL channel characteristics such as channel gains and phases. In case of a time-division duplexing (TDD) transmission, there is channel reciprocity between the UL and DL channels. This means that the UL and DL channel responses are related, allowing information obtained from UL measurements to be used for DL transmission. For example, the BS can perform DL MIMO precoding based on the extracted UL channel state information (CSI) from the received pilot signals or SRSs. Once the DL MIMO precoding matrix is determined, the BS can use it to precode the DL data transmission, which helps in mitigating the effects of channel fading and interference and improving the quality of the received signal at the UEs. However, this method suffers from the fact that SRS resources are limited and if many UEs need to be accommodated, these SRS resources need to be reused, thus creating interference, which limits the accuracy of channel estimation and hence MIMO performance. Although several schemes to mitigate this problem, such as SRS multiplexing in the time and frequency domain, SRS cyclic shift hopping or combinations of all these, the SRS interference issue remains a limiting factor for reciprocity-based MIMO in currently deployed systems.

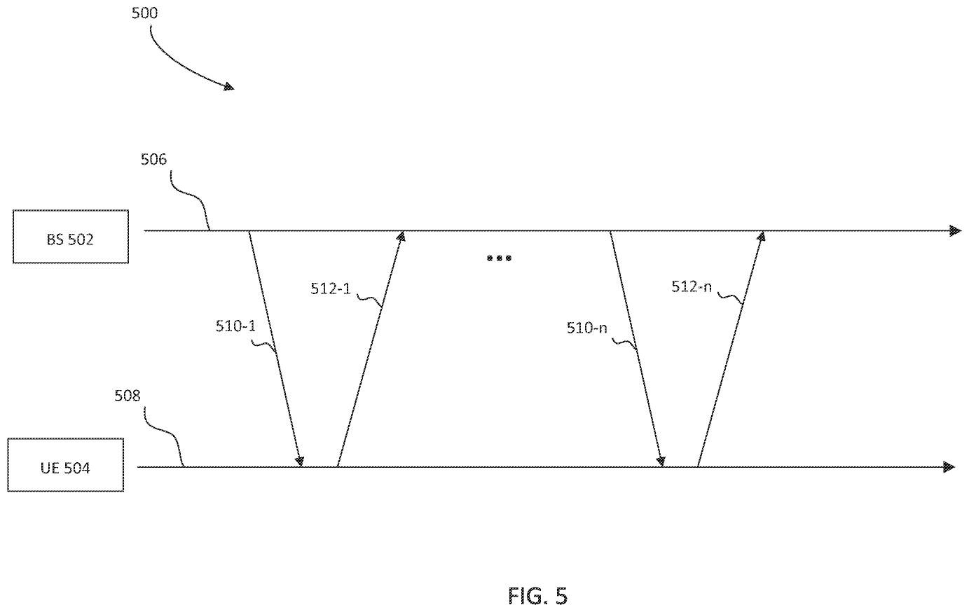

Another conventional method for estimating the channel, applicable to both TDD and frequency division duplex (FDD), is performed by a UE wherein the UE uses Channel State Information Reference Signals (CSI-RS) transmitted from the BS to generate a Channel State Information (CSI) report that comprises: Precoding Matrix Indicator (PMI), Rank Indicator (RI) and Channel Quality Indicator (CQI). FIG. 5 illustrates an exemplary signaling diagram of such method. As can be seen, a BS 502 may be configured to periodically transmit known pilot signals 510-1 to 510-n to a UE 504 during specific time slots represented on a BS time axis 506, wherein the pilot signals 510-1 to 510-n are known to both the BS 502 and the UE 504. The UE 504 may then use the pilot signals 510-1 to 510-n to estimate the channel characteristics. That is, during the reception of the pilot signals 510-1 to 510-n, the UE 504 may measure the received signal strength, phase, and other relevant parameters, and use these parameters to estimate the channel characteristics between the UE 504 and the BS 502. After performing the channel estimation, the UE 504 may be configured to send feedback signals 512-1 to 512-n back to the BS 502 along a UE time axis 508, wherein each of the feedback signals 512-1 to 512-n may comprise a CSI report that comprises at least one of: a PMI, an RI and a CQI. The BS 502 may then use the feedback signals 512-1 to 512-n to adapt its transmission parameters, such as modulation, coding, and beamforming in a precoding process, to optimize communication with the UE 504. For transmission with medium and high speeds, this method has been found to suffer from the “channel aging” problem. That is, that by the time the BS 502 receives the feedback signals 512 generated from the UE, the CSI report included in the feedback signals 512 may become dated as the channel condition has changed significantly during the UE measurement and UE reporting interval. To overcome this problem, complex channel prediction schemes have been proposed in the prior art. However, these channel prediction schemes may significantly increase UE complexity and power consumption. Therefore, there is a need for a simpler method to overcome the SRS capacity problem associated with UL CSI estimation and the channel aging problem associated with DL CSI estimation.

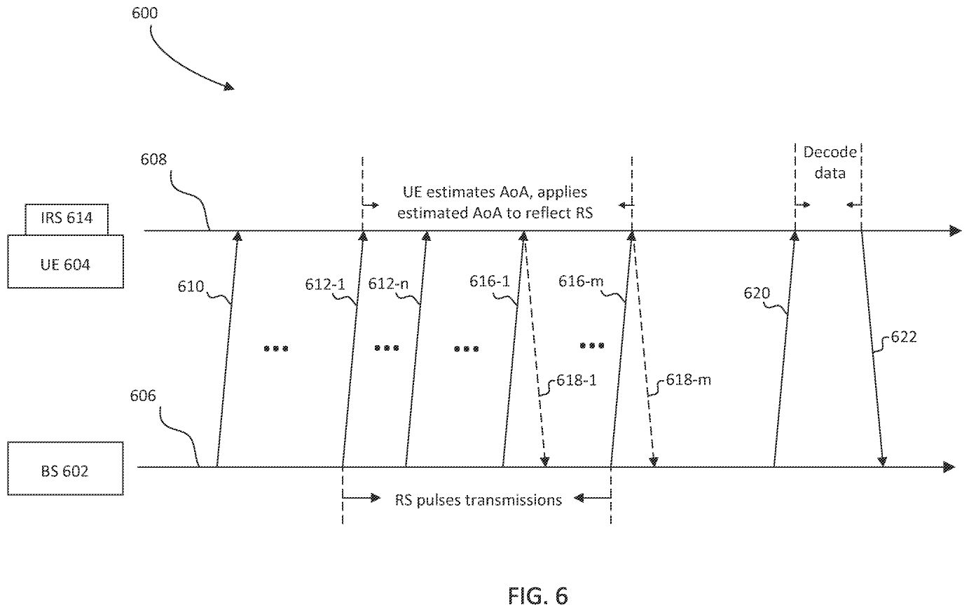

FIG. 6 illustrates an exemplary signaling diagram for IRS installed UE channel estimation performed at a BS, in accordance with some embodiments of the present disclosure. In some embodiments, a BS 602 may receive a measurement initiation request from a location management server (LMS), wherein the measurement initiation request may be a new radio (NR) Reference Signal Received Power (RSRP) measurement initiation request, an NR Reference Signal Received Quality (RSRQ) measurement initiation request, an Enhanced Cell Identity (E-CID) measurement initiation request message, an Evolved Universal Terrestrial Radio Access Network Reference Signal Received Power (E-UTRA RSRP) measurement initiation request message, Evolved Universal Terrestrial Radio Access Network Reference Signal Received Quality (E-UTRA RSRQ) measurement initiation request message, or an Observed Time Difference Of Arrival (OTDOA) measurement initiation request message. In some embodiments, the measurement initiation request may indicate a request for UE positioning based on IRS. In some other embodiments, to optimize beam management, the BS 602 may request the LMS to initiate a UE positioning calculation procedure for a UE 604 coupled to an IRS 614.

In some embodiments, the measurement initiation request comprises downlink positioning reference signal (DL-PRS) configurations, wherein the DL-PRS configurations comprise at least one of: positioning reference signal (PRS) resources, muting resources, PRS pattern and periodicity, and a list of measurements to be reported back to the core network, wherein the list of measurements comprises at least one of: a Round-Trip-Delay (RTD), a Time-of-Arrival (ToA), a Received Signal Received Power (RSRP), an Angle-of-Arrival (AoA), and an Angle-of-Departure (AoD) of the PRS transmission. In some other embodiment, the DL-PRS configurations are pre-configured in the BS 602. In yet some another embodiments, the DL-PRS configurations are pre-configured in the UE 604, and the UE 604 is pre-configured to reflect incident signals from the BS 602 towards the same direction as the incident signals.

In some embodiments, upon receiving the measurement initiation request, the BS 602 may transmit a first signal 610 along a time axis 606 to the UE 604. In some embodiments, the first signal 610 comprises a configuration message, wherein the configuration message comprises an indication to instruct the UE 604 to receive and reflect reference signals back towards the corresponding transmitting node that sends the reference signals. In some embodiments, the indication instructs the UE 604 to reflect the reference signals back to the corresponding transmitting node using the IRS 614. In some other embodiments, the indication instructs the UE 604 to reflect the reference signals back to the corresponding transmitting node in the same direction of the incident reference signals. In yet some other embodiments, the indication instructs the UE 604 to reflect reference signals transmitted from the BS 602 by focusing on a direction such that the reflected signals reach the BS 602 with a sufficient strength at the receiver of the BS 602. In still some other embodiments, the configuration message comprises an instruction to set angles of departure for the reflected reference signals. In still some other embodiments, the configuration message comprises an instruction to set the angle of departure for the reflected reference signals to be the same as the angle of arrival of the reference signals received at the UE 604. In still some other embodiments, the configuration message comprises an instruction to instruct the UE 604 to first receive a plurality of first signals and a plurality of second signals, and then reflect the plurality of second signals back towards the BS 602 based on at least one angle of arrival (AoA) of the plurality of first signals using an IRS 614. In some embodiments, the IRS 614 reflects the plurality of second signals to generate a plurality of third signals, and the configuration message comprises an instruction to instruct the UE 604 to set at least one angle of departure (AD) for the plurality of third signals based on at least one AoA of the plurality of first signals measured at the UE 604. In some embodiments, the configuration message comprises an instruction to set the at least one AoD for the plurality of third signals to be the same as the at least one AoA of the plurality of first signals. In still some other embodiments, the configuration message comprises an instruction to set reference signal identification (ID), the UE ID, UE-specific reference signal DL resource assignment, etc. Then the BS 602 may be configured to perform a channel estimation on the received reflected reference signals to compute a precoder for the data transmission to the same target UE 604. In some embodiments, The BS 602 processes the received reflected reference signals for channel estimation and determines the precoder, modulation order and the coding rate for the data transmission to the target UE 604.

In some embodiments, the first signal 610 transmitted from the BS 602 to the UE 604 may be transmitted through system information block (SIB) signaling, radio resource control (RRC) signaling, medium access control-control element (MAC-CE) signaling, or downlink control information (DCI) signaling. In some other embodiments, the indication for instructing the UE 604 to reflect the DL-PRS may be pre-configured in the UE 604 or sent to the UE 604 from the BS 602 via a paging message. In one embodiment, the first signal 610 is transmitted through an SIB Type 1 (SIB1) signaling message, wherein the SIB1 signaling message is periodically transmitted from the BS 602 to the UE 604, such that the SIB1 signaling message can be transmitted to the UE 604 even when the UE 604 is still in IDLE or INACTIVE state.

After transmitting the first signal to the UE 604, the BS 602 may be configured to transmit a plurality of second signals 612-1 to 612-n and a plurality of third signals 616-1 to 616-m to the UE 604. In some embodiments, the plurality of second signals 612-1 to 612-n comprises a first respective train of reference signal pulses, and the plurality of third signals 616-1 to 616-m comprises a second respective train of reference signal pulses. Upon receiving the plurality of second signals 612-1 to 612-n by a plurality of sensors on the IRS 614, the IRS may forward the plurality of second signals 612-1 to 612-n to a UE processor module or a modulator-demodulator (modem) of the UE 604, wherein the UE processor module or the modem of the UE 604 determines an AoA θᵢ using the plurality of second signals 612-1 to 612-n based on the algorithms discussed with reference to FIG. 3.

After computing the AoA θᵢ using the plurality of second signals 612-1 to 612-n, the IRS 614 may reflect the subsequent received plurality of third signals 616-1 to 616-m using a plurality of reconfigurable reflecting elements on the IRS 614. In some embodiments, the IRS 614 is configured to reflect the plurality of third signals 616-1 to 616-m to produce a plurality of fourth signals 618-1 to 618-m along a time axis 608, wherein the AoD θᵣ of the plurality of fourth signals 618-1 to 618-m is computed as θᵣ=θᵢ, such that the direction of the focused reflected plurality of fourth signals 618-1 to 618-m reaches the serving BS 602 with sufficient received strength, as discussed above with reference to FIG. 4. In some embodiments, the plurality of fourth signals 618-1 to 618-m is transmitted from the IRS 614 to the BS 602 by focusing a transmission direction towards the BS 602 such that a signal strength of the plurality of fourth signals 618-1 to 618-m is higher than a threshold.

In some embodiments, upon receiving the plurality of fourth signals 618-1 to 618-m, the BS 602 may perform channel estimation based on the received fourth signals 618-1 to 618-m. For example, the BS 602 may perform DL MIMO precoding based on the extracted UL CSI from the received plurality of fourth signals 618-1 to 618-m. Once the DL MIMO precoding matrix is determined, the BS 602 can use the DL MIMO precoding matrix to precode the DL data transmission, which helps in mitigating the effects of channel fading and interference and improving the quality of the received signal at the UE 604. In one embodiment, the CSI includes determined the RSRP and the channel covariance and rank. In another embodiment, the BS 602 transmits a fifth signal 620 to the UE 604, wherein the fifth signal 620 comprises precoded data obtained using the DL MIMO precoding matrix that is determined from the extracted UL CSI. Upon receiving the fifth signal 620, the UE 604 may send a sixth signal 622 back to the BS 602, wherein the sixth signal 622 comprises an acknowledgment (ACK) or a negative acknowledgment (NACK) depending upon the precoded data was decoded successfully or not, respectively.

Relative to the conventional channel estimation methods, one major advantage of the disclosed method is the real-time processing of channel estimation, which does not suffer from the channel estimation aging problem. Other advantages of the disclosed method include uplink resource savings, channel tracking with reduced signaling overhead, and channel estimation without UE transmissions. In case of a tracking mode applied to the UE 604, wherein the state of the UE 604 is actively tracked by the network, the UE 604 is not required to be scheduled for the CSI report transmission. In this way, UE tracking can be performed even during the listen-only mode (e.g., IDLE mode), which allows the network to anticipate and prepare for potential handovers as the UE 604 moves between different cells. This ensures a smooth transition when the UE 604 becomes active again and starts to initiate communication.

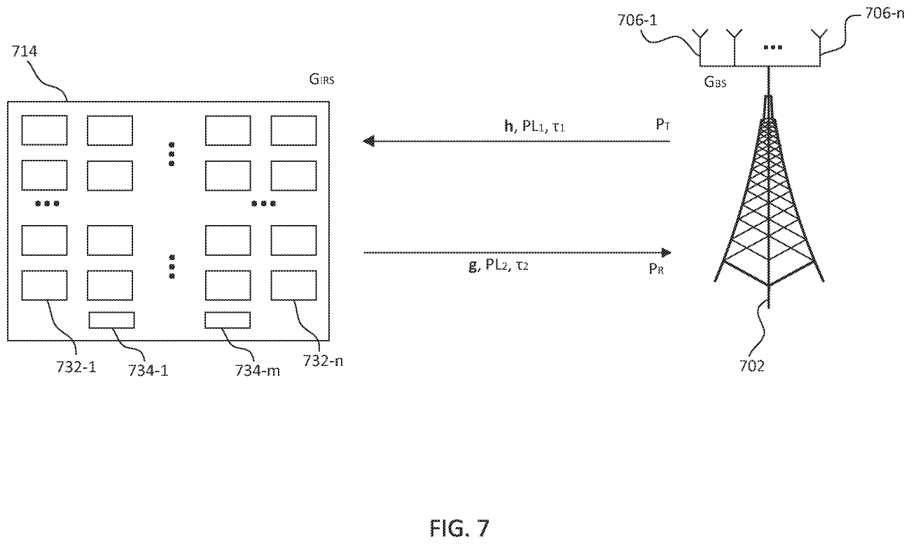

FIG. 7 illustrates an exemplary diagram of a communication link between base station antennas and IRS-UE, in accordance with some embodiments of the present disclosure. In some embodiments, a BS 702 comprises a plurality of antennas 706-1 to 706-n, which may be arranged in an antenna array and be in communication with a UE coupled to an IRS 714, wherein the IRS 714 comprises a plurality of reconfigurable reflecting elements 732-1 to 732-n. In one embodiment, the plurality of antennas 706-1 to 706-n may be in communication with a plurality of sensors 734-1 to 734-m in the IRS 714 to form a MIMO system. For example, a MIMO channel can be formed between the i-th antenna element in the plurality of antennas 706-1 to 706-n with i=1, . . . , n and the j-th sensor element of the plurality of sensors 734-1 to 734-m with j=1, . . . , m. In some embodiments, the communication channel from the BS 702 to the IRS 714 may be represented by a channel matrix h∈ [symbol] . Similarly, the communication channel from the IRS 714 and to BS 702 may be represented by a channel matrix g∈ [symbol] .

In some embodiments, as shown in FIG. 5, the pathlosses from the BS 702 to the IRS 714 and from the IRS 714 to the BS 702 may be represented by PL₁ and PL₂, respectively. The propagation delays from the BS 702 to the IRS 714 and from the IRS 714 to the BS 702 may be represented by τ₁ and τ₂, respectively. In some embodiments, the BS 702 transmits each pulse at a transmit power P_{T}, and the BS 702 has a first transmission power gain (e.g. a net multiple-antenna gain), G_{BS}. On the UE side, the IRS 714 reflects signals at a receive power P_{R}. In some embodiments, the IRS 714 has a second transmission power gain (e.g. the total reflector's gain) that can be represented by G_{IRS}, wherein G_{IRS} may be a function of the number of reconfigurable reflecting elements in the IRS 714, the size of each reconfigurable reflecting element, and the operating frequency of the received signals.

In some embodiments, the IRS 714 is configured to reflect reference signals transmitted from the BS 702, wherein the BS 702 receives a delayed-Doppler shifted version of the transmitted reference signals. The propagation delay and the Doppler shift depend on the distance and the velocity of the target UE, respectively. In some embodiments, both the propagation delay and the Doppler shift are considered in the receiver design of the BS 702. In some other embodiments, the delay and the Doppler shift are not considered in the receiver design of the BS 702, and the BS 702 receives reflected reference signals from the IRS 714, wherein the reflected reference signals are expressed as r=g(hs_{b})+n, wherein r denotes the reflected reference signals received at the BS 702, g and h denote the communication channel matrix from the IRS 714 to the BS 702 and the communication channel matrix from the BS 702 to the IRS 714, respectively, s_{b} denotes the reference signals transmitted from the BS 702 to the IRS 714, and n denotes a complex Gaussian noise CN(0,N₀Iₙ), wherein Iₙ is the identify matrix of size n×n and N₀ is a scalar parameter used to scale the covariance matrix of the complex Gaussian noise. In some embodiments, the communication channel from the IRS 714 and to BS 702 and the communication channel from the BS 702 to the IRS 714 have reciprocity. Therefore, g=h^{T} wherein T denotes the transpose operation of a matrix. As a result, the received signal at the BS 702 may be expressed as r=h^{T}(hs_{b})+n, wherein the received channel matrix h^{T}h is used for channel estimation.

In some embodiments, the reciprocity between the two channels from the BS 702 to the IRS 714 and from the IRS 714 to the BS 702 results in PL₁=PL₂=PL. In such a case, the receive power P_{R} of each reflected reference signal pulse at the BS 702 may be expressed as: P_{R}=P_{T}+G_{BS_TX}−2PL+G_{IRS}+G_{BS_RX}. Accordingly, the reference signal transmit power P_{T} at the BS 702, the G_{BS_TX} and G_{BS_RX}-antenna gains during BS transmission and reception, respectively, and the total reflector's gain G_{IRS} must be sufficient to compensate for the pathloss 2PL mentioned above such that the received reflected signal's strength is strong enough for the channel estimation signal processing. In some embodiments, G_{BS} represents a total BS antenna gain when transmitting a reference signal and when receiving the reflection. An exemplary advantage of processing reflections at the BS is that the sum gain at the BS (G_{BS}) allows for efficient and practical design of the IRS (e.g., a relatively low number of elements at the frequency of operation can be employed). In accordance with some embodiments, in both FDD and TDD cases, G_{BS} represents a sum of antenna gain applied during transmission (TX) and then at reflection and reception (RX). Therefore, in accordance with some embodiments, an incident signal and a reflected signal can benefit from the TX antenna gain and the RX antenna gain, respectively. Thus, the total gain due to the BS Tx antenna gain, the IRS reflection gain, and the BS Rx gain will compensate for a double-pathloss experienced by the transmitted signal towards the IRS-UE.

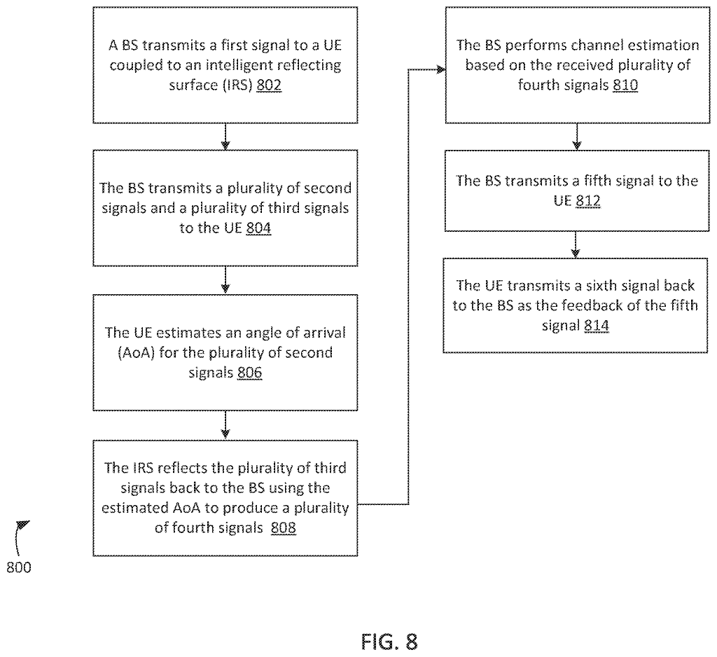

FIG. 8 illustrates an example method 800 for performing IRS installed UE channel estimation, in accordance with some embodiments. The operations of method 800 presented below are intended to be illustrative. In some embodiments, method 800 may be accomplished with one or more additional operations not described and/or without one or more of the operations discussed. Additionally, the order in which the operations of method 800 are illustrated in FIG. 8 and described below is not intended to be limiting.

At step 802, a BS transmits a first signal to a UE coupled to an IRS. In some embodiments, the first signal comprises an indication to instruct the UE to receive reference signals and reflect the reference signals using the IRS back towards the BS. In some other embodiments, the indication instructs the UE to reflect the reference signals back to the corresponding transmitting node in the same direction of the incident reference signals. In yet some other embodiments, the indication instructs the UE to reflect reference signals transmitted from the BS by focusing on a direction such that the reflected signals reach the BS with a sufficient strength at the receiver of the BS. In still some other embodiments, the first signal comprises a configuration message that comprises an instruction to set angles of departure for the reflected reference signals. In still some other embodiments, the configuration message comprises an instruction to set the angle of departure for the reflected reference signals to be the same as the angle of arrival of the reference signals received at the UE. In still some other embodiments, the configuration message comprises an instruction to set reference signal ID, the UE ID, UE-specific reference signal DL resource assignment, etc. The BS may then be configured to perform a channel estimation on the received reflected reference signals to compute a precoder for the data transmission to the same target UE. In some embodiments, The BS processes the received reflected reference signals for channel estimation and determines the precoder, modulation order and the coding rate for the data transmission to the target UE. In some embodiments, the first signal may be transmitted through SIB signaling, RRC signaling, MAC-CE signaling, DCI signaling, or SIB1 signaling message, wherein the SIB1 signaling message is periodically transmitted from the BS to the UE, such that the SIB1 signaling message can be transmitted to the UE even when the UE is in IDLE or INACTIVE state.

At step 804, the BS transmits a plurality of second signals to the UE. In some embodiments, each of the plurality of second signals comprises a respective reference signal with a respective AoA at the UE for performing UE positioning, such that the plurality of second signals covers the entire serving area of the BS. In some embodiments, the plurality of second signals comprises a first respective train of reference signal pulses, and the plurality of third signals comprises a second respective train of reference signal pulses.

At step 806, the UE may be configured to measure the respective AoA θᵢ for each of the plurality of second signals using a plurality of sensors on the IRS. In some embodiments, a UE processor module in the UE may be configured to estimate the AoA for each of the plurality of second signals using one of the following algorithms: Capon's Minimum Variance, MUSIC, ESPRIT, and Matrix-Pencil method.

At step 808, the IRS may be configured to reflect each of the plurality of third signals back towards the BS using a plurality of reconfigurable reflecting elements on the IRS with the same direction as measured in the respective AoA for each of the plurality of second signals. In one embodiment, the IRS comprises a plurality of reconfigurable reflecting elements, which is coordinated to reflect each of the plurality of second signals back towards the BS with the same direction as measured in the AoA. In some embodiments, the IRS is configured to reflect the plurality of third signals to produce a plurality of fourth signals, wherein the AoD θᵣ of the plurality of fourth signals is computed as θᵣ=θᵢ, such that the direction of the focused reflected plurality of fourth signals reaches the serving BS with sufficient received strength, as discussed above with reference to FIG. 4.

At step 810, upon receiving the plurality of fourth signals, the BS may be configured to perform channel estimation based on the received fourth signals. In some embodiments, the BS may perform DL MIMO precoding based on the extracted UL CSI from the received plurality of fourth signals. Once the DL MIMO precoding matrix is determined, the BS can use the DL MIMO precoding matrix to precode the DL data transmission, which helps in mitigating the effects of channel fading and interference and improving the quality of the received signal at the UE. In one embodiment, the CSI includes determined the RSRP and the channel covariance and rank.

At step 812, the BS transmits a fifth signal to the UE. In some embodiments, the fifth signal comprises precoded data obtained using the DL MIMO precoding matrix that is determined from the extracted UL CSI.

At step 814, upon receiving the fifth signal, the UE may send a sixth signal back to the BS, wherein the sixth signal comprises an ACK or a NACK depending upon the precoded data was decoded successfully or not, respectively.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuitry, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and functions described herein can be implemented within or performed by one or more circuits or circuitry. As used herein, the term “circuitry” refers to and includes any one or more of the following: discrete circuit components or devices coupled to each other to form circuit, logic circuitry, integrated circuits, application specific integrated circuits, state machines, general purpose processors, special purpose processors, digital signal processors (DSP), microprocessors, field programmable gate arrays (FPGA) or other programmable logic devices, or any combination thereof. Circuitry can further include antennas, reflectors, transmitters, receivers and/or transceivers to communicate with various components, devices or nodes within a communication network. As used herein, the term “processor” refers to a combination of structures including processing circuitry, a memory coupled to the processing circuitry, and executable code stored in the memory that when executed by the processing circuitry perform the functions or operations instructed by the executable code.

If implemented in software, the functions described herein can be stored as one or more instructions or code on a computer-readable medium that when executed by a computer or processor perform the stated functions. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, non-transitory computer-readable media can include RAM, ROM, EEPROM, CD-ROM or other optical disk storage, magnetic disk storage or other magnetic storage devices, or any other medium that can be used to store desired program code in the form of instructions or data structures and that can be accessed and executed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method comprising:
receiving, at a wireless communication device, a first signal from a wireless communication node, wherein the first signal comprises a configuration message to instruct the wireless communication device to:
receive a plurality of second signals and a plurality of third signals, and
reflect the plurality of third signals back towards the wireless communication node based on at least one angle of arrival (AoA) of the plurality of second signals using an Intelligent Reflecting Surface (IRS) coupled to the wireless communication device;
receiving, at the wireless communication device, the plurality of second signals from the wireless communication node;
receiving, at the wireless communication device, the plurality of third signals from the wireless communication node; and
reflecting, at the wireless communication device, the plurality of third signals to generate a plurality of fourth signals using the IRS, wherein the plurality of fourth signals is used to perform a channel estimation between the wireless communication device and the wireless communication node.

2. The method of claim 1, further comprising measuring, at the wireless communication device, the at least one AoA of the plurality of second signals, wherein the first signal comprises the configuration message to instruct the wireless communication device to set at least one angle of departure (AoD) for the plurality of fourth signals based on the at least one AoA of the plurality of second signals.

3. The method of claim 2, wherein the first signal is:
transmitted through system information block (SIB) signaling;
transmitted through SIB Type 1 (SIB1) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

4. The method of claim 1, wherein the plurality of fourth signals is transmitted from the wireless communication device to the wireless communication node by focusing a transmission direction towards the wireless communication node such that a signal strength of the plurality of fourth signals is higher than a threshold.

5. The method of claim 2, wherein the configuration message further comprises an instruction to set:
the at least one AoD for the plurality of fourth signals to be the same as the at least one AoA of the plurality of second signals; and
at least one of: a reference signal identification (ID), a device ID for the wireless communication device, and a device-specific reference signal downlink resource assignment.

6. The method of claim 1, wherein the at least one AoA of the plurality of second signals is determined using one of the following: Capon's Minimum Variance method, MUItiple SIgnal Classification (MUSIC) method, Estimation of Signal Parameters via Rotational Invariance Techniques (ESPRIT) method, and Matrix-Pencil method.

7. A wireless communication device comprising:
a transceiver configured to:
receive a first signal from a wireless communication node, wherein the first signal comprises a configuration message to instruct the wireless communication device to:
receive a plurality of second signals and a plurality of third signals, and
reflect the plurality of third signals back towards the wireless communication node based on at least one angle of arrival (AoA) of the plurality of second signals, and
receive the plurality of second signals and the plurality of third signals from the wireless communication node;
at least one processor coupled to the transceiver and configured to determine the at least one AoA of the plurality of second signals; and
an Intelligent Reflecting Surface (IRS) configured to reflect the plurality of third signals to generate a plurality of fourth signals based on the at least one AoA of the plurality of second signals, wherein the plurality of fourth signals is used to perform a channel estimation between the wireless communication device and the wireless communication node.

8. A non-transitory computer readable medium storing computer-executable instructions which when executed cause the wireless communication device to perform the method of claim 1.

9. Circuitry configured to cause the wireless communication device to perform the method of claim 1.

10. A method comprising:
transmitting, at a wireless communication node, a first signal to a wireless communication device, wherein the first signal comprises a configuration message to instruct the wireless communication device to:
receive a plurality of second signals and a plurality of third signals, and
reflect the plurality of third signals back towards the wireless communication node based on at least one angle of arrival (AoA) of the plurality of second signals using an Intelligent Reflecting Surface (IRS) coupled to the wireless communication device;
transmitting, at the wireless communication node, the plurality of second signals and the plurality of third signals to the wireless communication device; and
receiving, at the wireless communication node, a plurality of fourth signals generated by the IRS, wherein the plurality of fourth signals is generated by reflecting the plurality of third signals based on the at least one AoA of the plurality of second signals, and wherein the plurality of fourth signals is used to perform a channel estimation between the wireless communication device and the wireless communication node.

11. The method of claim 10, wherein:
a respective reception power for each of the plurality of fourth signals is determined by:
obtaining a respective transmission power for a respective one of the plurality of third signals;
obtaining a first sum of a first path loss value from the wireless communication node to the wireless communication device and a second path loss value from the wireless communication device to the wireless communication node;
obtaining a first transmission power gain associated with the wireless communication node and a second transmission power gain associated with the wireless communication device, wherein the first transmission power gain comprises a sum of a transmission power gain and a reception power gain of the wireless communication node; and
subtracting the first sum from a second sum, wherein the second sum is obtained by adding the respective transmission power, the first transmission power gain and the second transmission power gain.

12. The method of claim 10, wherein the wireless communication node is configured to:
perform the channel estimation between the wireless communication device and the wireless communication node using the plurality of fourth signals; and
determine a precoder, a modulation order and a coding rate, wherein the precoder, the modulation order and the coding rate are used for data transmission between the wireless communication node and the wireless communication device.

13. The method of claim 10, wherein the first signal comprises a configuration message to instruct the wireless communication device to set at least one angle of departure (AoD) for the plurality of fourth signals based on the at least one AoA of the plurality of second signals measured at the wireless communication device.

14. The method of claim 13, wherein the first signal is:
transmitted through system information block (SIB) signaling;
transmitted through SIB Type 1 (SIB1) signaling;
transmitted through radio resource control (RRC) signaling;
transmitted through medium access control-control element (MAC-CE) signaling;
transmitted through downlink control information (DCI) signaling;
transmitted via a paging message; or
pre-configured in the wireless communication device.

15. The method of claim 10, wherein the plurality of fourth signals is transmitted from the wireless communication device to the wireless communication node by focusing a transmission direction towards the wireless communication node such that a signal strength of the plurality of fourth signals is higher than a threshold.

16. The method of claim 13, wherein the configuration message further comprises an instruction to set:
the at least one AoD for the plurality of fourth signals to be the same as the at least one AoA of the plurality of second signals; and
at least one of: a reference signal identification (ID), a device ID for the wireless communication device, and a device-specific reference signal downlink resource assignment.

17. (canceled)

18. A non-transitory computer readable medium storing computer-executable instructions which when executed cause the wireless communication node to perform the method of 10.

19-20. (canceled)
